(19) United States
(12) Patent Application Publication
(10) Pub. No.: US 2006/0002384 A1
(43) Pub. Date: Jan. 5, 2006

(54) NETWORK SYSTEM AND CONNECTING METHOD THEREOF

(76) Inventor: Heng-Chien CHEN, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/710,336

(22) Filed: Jul. 1, 2004

(51) Int. Cl. H04L 12/56

(52) U.S. Cl. 370/389

(57) ABSTRACT

A network system and a connecting method thereof. The network system includes a first network device having a first MAC address, a second network device having a second MAC address, a first IP-based device having a first IP address for transmitting the data to the first network device through the first MAC address, a second IP-based device having a second IP address for receiving the data outputted from the second network device through the second MAC address, and a host having a predetermined IP address and being connected to the first IP-based device and the second IP-based device through the predetermined IP address, the first IP address, and the second IP address. The host has a look-up table for recording the first MAC address mapping to the first IP address, wherein the second IP-based device checks the look-up table for directing the data to the first IP-based device.

### BACKGROUND OF INVENTION

1. Field of the Invention

The present invention relates to a network system and a connecting method thereof, and more particularly, to a network system comprising network devices capable of performing data transaction through media access control (MAC) addresses and the Internet and a connecting method thereof.

2. Description of the Prior Art

With the Internet growth, various applications are developed through the Internet. For example, clients can upload/download data to the remote host or other clients in the Internet network system, which utilizes IP addresses to construct network protocols for packet transmission. In addition, local area networks (LANs) are provided for packet transmission in local buildings. When a terminal in an LAN transmits data to another terminal in another LAN, a virtual private network (VPN) server can be used to join two separate LANs together. Please refer to FIG. 1. FIG. 1 is a diagram of a prior art network system 10. The network system 10 connects an LAN 12 to an LAN 14 through the Internet 16. The LAN 12 comprises a VPN server 20, a hub 22, and a plurality of network device 24. The LAN 14 comprises a VPN server 30, a hub 32, and a plurality of network device 34. The VPN servers 20 and 30 utilize individual static IP addresses to interconnect each other through the Internet 16. The hubs 22 and 32 respectively assign virtual IP addresses to the network devices 24 and 34. When the network devices 24 transmit packets to the network devices 34, the network devices 24 transmit the packets to the VPN server 20 through the virtual IP addresses allocated by the hub 22, the VPN server 20 directs data to the packets to the VPN server 30, and then the VPN server 30 transmits the packets to the network devices 34.

However, the prior art network system 10 needs static IP addresses to connect two VPN servers of the LANs through the Internet via a peer-to-peer connection. In each LAN, the network devices need virtual IP addresses to connect to the VPN server. Thus, The network system 10 takes much cost for the static and the virtual IP addresses, and is only capable of providing the connection between one LAN to another LAN in a peer-to-peer way.

### SUMMARY OF INVENTION

It is therefore a primary objective of the claimed invention to provide a network system and a connecting method thereof to solve the above-mentioned problem.

According to an embodiment of the claimed invention, a network system is disclosed. The network system includes a first network device having a first MAC address, a second network device having a second MAC address for transmitting a data to the first network device, a first IP-based device having a first IP address and being connected to the first network device for transmitting the data to the first network device through the first MAC address, a second IP-based device having a second IP address and being connected to the second network device for receiving the data outputted from the second network device through the second MAC address, and a host having a predetermined IP address and being connected to the first IP-based device and the second IP-based device through the predetermined IP address, the first IP address, and the second IP address. The host has a look-up table for recording the first MAC address mapping to the first IP address, wherein the second IP-based device checks the look-up table for directing the data to the first IP-based device.

In addition, the embodiment of the claimed invention provides a connecting method of a network system. The connecting method includes providing a first network device with a first MAC address, providing a second network device with a second MAC address for transmitting a data to the first network device, providing a first IP-based device with a first IP address and connecting the first IP-based device to the first network device for transmitting the data to the first network device through the first MAC address, providing a second IP-based device with a second IP address and connecting the second IP-based device to the second network device for receiving the data outputted from the second network device through the second MAC address, providing a host with a predetermined IP address and connecting the host to the first IP-based device and the second IP-based device through the predetermined IP address, the first IP address, and the second IP address, and recording the first MAC address mapping to the first IP address in the host for directing the data to the first IP-based device.

It is an advantage of the claimed invention that the network devices with MAC addresses can transmit data to any network devices with MAC addresses in the network system through the Internet. The network system takes less cost for assigning the IP addresses to the IP-based devices. In addition, the network system according to the present invention can link a lot of LANs through the Internet, and is free of limitations introduced by prior art peer-to-peer connections.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a prior art network system.

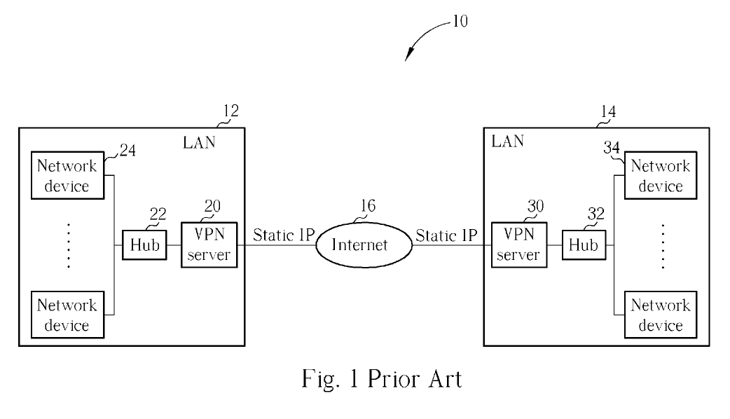

FIG. 2 is a diagram of a network system according to the present invention.

FIG. 3 is a diagram of a look-up table shown in FIG. 2.

FIG. 4 is a diagram of a routing table shown in FIG. 2.

FIG. 5 is a diagram of another routing table shown in FIG. 2.

FIG. 6 is a flow chart illustrating operation of the network system shown in FIG. 2.

FIG. 7 is a diagram illustrating a packet transmitted between a network device and an IP-based device shown in FIG. 2.

FIG. 8 is a diagram illustrating a packet transmitted between IP-based devices shown in FIG. 2.

### DETAILED DESCRIPTION

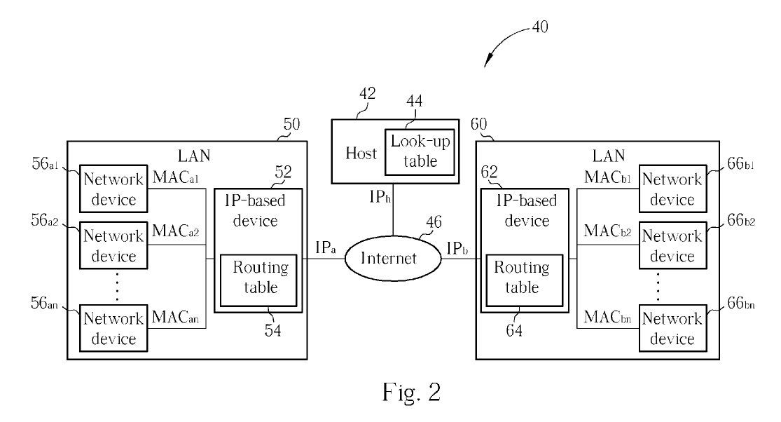

Please refer to FIG. 2. FIG. 2 is a diagram of a network system 40 according to the present invention. The network system 40 connects a host 42 to the Internet 46 through a predetermined IP address IPₕ, connects an LAN 50 to the Internet 46 through an IP address IPₐ, and connects an LAN 60 to the Internet 46 through an IP address IP_{b}. The LAN 50 comprises an IP-based device 52 and a plurality of network devices 56ₐ₁, 56ₐ₂, and 56ₐₙ (only three network devices are shown for simplicity). The IP-based device 52 is connected to the Internet 46 through the IP address IPₐ, and each of the network devices 56ₐ₁, 56ₐ₂, and 56ₐₙ is respectively connected to the IP-based device 52 through a corresponding media access control (MAC) address MACₐ₁, MACₐ₂, and MACₐₙ. Concerning the LAN 60, it comprises an IP-based device 62 and a plurality of network devices 66_{b1}, 66_{b2}, and 66_{bn} (only three network devices are shown for simplicity). The IP-based device 62 is connected to the Internet 46 through the IP address IP_{b}, and each of the network devices 66_{b1}, 66_{b2}, and 66_{bn} is respectively connected to the IP-based device 62 through a corresponding media access control (MAC) address MAC_{b1}, MAC_{b2}, and MAC_{bn}.

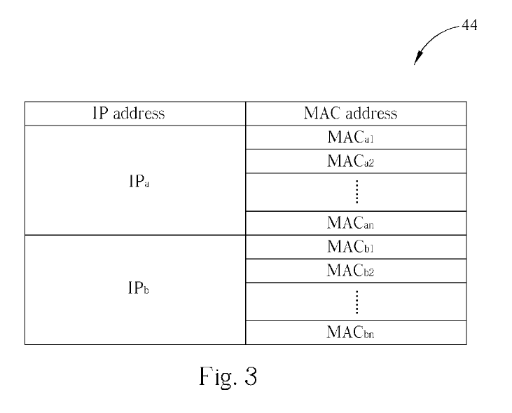

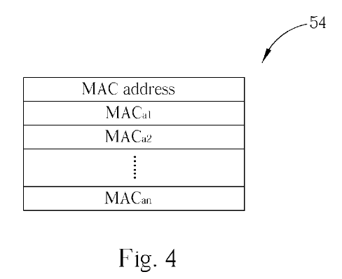

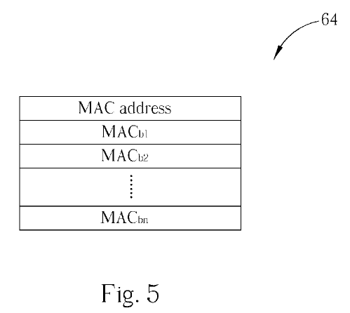

In this preferred embodiment, the host 42 has a look-up table 44 for recording mapping information between the MAC addresses and the IP addresses. Please refer to FIG. 3. FIG. 3 is a diagram of the look-up table 44 shown in FIG. 2. The look-up table 44 records the MAC addresses MACₐ₁-MACₐₙ mapping to the IP address IPₐ and the MAC addresses MAC_{b1}-MAC_{bn} mapping to the IP address IP_{b}. In addition, the IP-based devices 52 and 62 respectively comprise routing tables 54 and 64 for recording the MAC addresses handled by the corresponding network devices 52 and 62. Please refer to FIG. 4 and FIG. 5. FIG. 4 is a diagram of the routing table 54 shown in FIG. 2, and FIG. 5 is a diagram of the routing table 64 shown in FIG. 2. As shown in FIG. 4, it is obvious that the routing table 54 records the MAC addresses MACₐ₁-MACₐₙ because the network devices 56ₐ₁-56ₐₙ are connected to the IP-based device 52. Similarly, the routing table 64 records the MAC addresses MAC_{b1}-MAC_{bn} because the network devices 66_{b1}-66_{bn} are connected to the IP-based device 62.

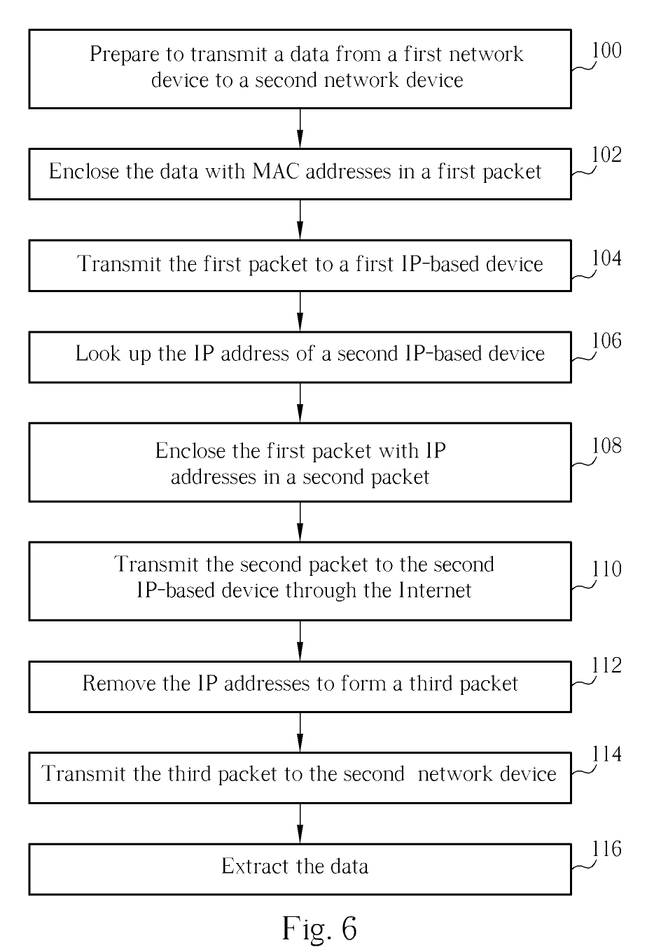

Please refer to FIG. 6. FIG. 6 is a flow chart illustrating operation of the network system 40 shown in FIG. 2. The operation includes the following steps:

Step 100: A first network device prepares to transmit a data to a second network device;

Step 102: The first network device encloses the data with MAC addresses of the first network device and the second network device in a first packet;

Step 104: The first network device transmits the first packet to a first IP-based device;

Step 106: The first IP-based device looks up the IP address of a second IP-based device mapping to the second network device;

Step 108: The first IP-based device encloses the first packet with the IP addresses of the first IP-based device and the second IP-based device in a second packet;

Step 110: The first IP-based device transmits the second packet to the second IP-based device through the Internet;

Step 112: The second IP-based device removes the IP addresses of the second packet to form a third packet after receiving the second packet;

Step 114: The second IP-based device transmits the third packet to the second network device; and

Step 116: The second network device extracts the data from the third packet.

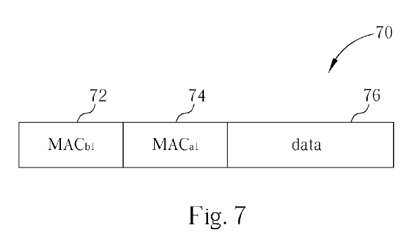

When the network device 56ₐ₁ prepares to transmit a data to the network device 66_{b1}, the network device 56ₐ₁ encloses the data with the MAC addresses of the network devices 56ₐ₁ and 66ₐ₁ in a first packet and transmits the first packet to the IP-based device 52 (steps 100, 102, and 104). Please refer to FIG. 7. FIG. 7 is a diagram illustrating a packet 70 transmitted between the network device 56ₐ₁ and the IP-based device 52 shown in FIG. 2. The packet 70 has a destination field used for recording an MAC address 72, a source field used for recording an MAC address 74, and a data field 76 used for carrying data. The network device 56ₐ₁ encloses the MAC address MAC_{b1} of the network device 66_{b1} in the destination field 72, the MAC address MACₐ₁ of the network device 56ₐ₁ in the source field 74, and the data in the data field 76. Then, the packet 70 is transmitted from the network device 56ₐ₁ to the IP-based device 52.

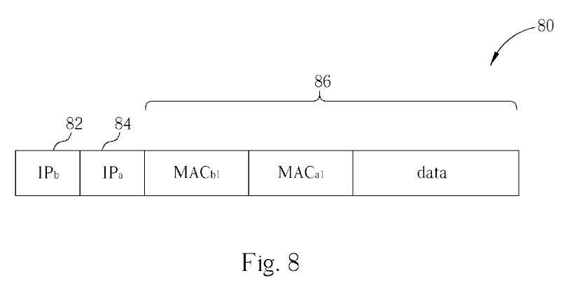

The IP-based device 52 looks up the look-up table 44 of the host 42 to query the IP address of the IP-based device 62 in charge of the network device 66_{b1} (step 106). Then, the IP-based device 52 encloses the packet 70 with the IP addresses of the IP-based devices 52 and 62 in a second packet and transmits the second packet to the IP-based device 62 through the Internet (steps 108 and 110). Please refer to FIG. 8. FIG. 8 is a diagram illustrating a packet 80 transmitted between the IP-based devices 52 and 62 shown in FIG. 2. The packet 80 has a destination field used for recording an IP address 82, a source field used for recording an IP address 84, and a data field 86 used for recording data. The IP-based device 52 encloses the IP address IP_{b} of the IP-based device 62 in the destination field 82, the IP address IPₐ of the IP-based device 52 in the source field 84, and the first packet 70 in the data field 86. That is, the data field 86 carries the first packet 70 currently transmitted from the network device 56ₐ₁ to the IP-based device 52 now. Then, the packet 86 is further transmitted from the IP-based device 52 to the IP-based device 62.

33 When the IP-based device 62 receives the packet 80, the IP-based device 62 checks if the destination field 82 of the packet 80 is the IP address IP_{b} of the IP-based device 62. If the destination field 82 is the IP address IP_{b}, the IP-based device 62 removes the fields of IP addresses 82 and 84 in the second packet 80 to form a third packet and transmits the third packet to the network device 66_{b1} (steps 112 and 114). The third packet is the same as the first packet 70. In other words, the third packet has a destinations field storing the MAC address MAC_{b1}, a source field recording the MAC address MACₐ₁, and a data field storing the wanted data. Next, the network device 66_{b1} checks if the destination field of the third packet is the MAC address MAC_{b1} of the network device 66_{b1}. If the destination field keeps the MAC address MAC_{b1}, the network device 66_{b1} starts extracting the data carried by the data field of the third packet (step 116).

In the embodiment of the present invention, the network system 40 can be a PBX system, wherein the host 42 is a PBX host and the network devices are PBX extensions. However, the network system 40 according to the present invention could be applied to any field of applications. The IP addresses IPₐ and IP_{b} of the IP-based devices 52 and 56 can be allocated by the host 42. In addition, the network devices only enclose MAC addresses in the destination and source fields for transmitting packets to other network devices. The IP-based devices are in charge of enclosing the corresponding IP addresses for transmitting packets to other IP-based devices over the Internet. Thus, with the help of the look-up table 44, the network devices positioned within different LANs can communicate with each other by merely enclosing data with MAC addresses. No peer-to-peer connection is required.

In contrast to the prior art, the network devices with MAC addresses can transmit data to another network devices through MAC addresses in the network system according to the present invention. The network system according to the present invention takes less cost for assigning the IP addresses. In addition, the network system according to the present invention can link a lot of LANs, and is free of the restrictions required by the prior art peer-to-peer connections.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A network system comprising:
a first network device having a first MAC address;
a second network device having a second MAC address for transmitting a data to the first network device;
a first IP-based device having a first IP address and being connected to the first network device for transmitting the data to the first network device through the first MAC address;
a second IP-based device having a second IP address and being connected to the second network device for receiving the data outputted from the second network device through the second MAC address; and
a host having a predetermined IP address and being connected to the first IP-based device and the second IP-based device through the predetermined IP address, the first IP address, and the second IP address, the host comprising a look-up table for recording the first MAC address mapping to the first IP address;
wherein the second IP-based device checks the look-up table for directing the data to the first IP-based device.

2. The network system of claim 1 wherein when the second network device transmits the data to the first network device, the second network device encloses the data with the first MAC address and the second MAC address in a first packet to transmit to the second IP-based device, the second IP-based device encloses the first packet with the first IP address and the second IP address in a second packet to transmit to the first IP-based device, the first IP-based device removes the first IP address and the second IP address from the second packet to form a third packet and transmits the third packet to the first network device, and the first network device extracts the data from the third packet.

3. The network system of claim 1 wherein the first and the second IP addresses are allocated by the host.

4. The network system of claim 1 wherein the first IP-based device comprises a first routing table for recording the first MAC address, and the second IP-based device comprises a second routing table for recording the second MAC address.

5. The network system of claim 1 wherein the host is a PBX host, and the first and the second network devices are PBX extensions.

6. A connecting method of a network system comprising:
providing a first network device with a first MAC address;
providing a second network device with a second MAC address for transmitting a data to the first network device;
providing a first IP-based device with a first IP address for transmitting the data to the first network device through the first MAC address;
providing a second IP-based device with a second IP address for receiving the data outputted from the second network device through the second MAC address;
providing a host with a predetermined IP address and connecting the host to the first IP-based device and the second IP-based device through the predetermined IP address, the first IP address, and the second IP address; and
recording the first MAC address mapping to the first IP address in the host for directing the data to the first IP-based device.

7. The connecting method of claim 1 wherein when the second network device transmits the data to the first network device, the second network device encloses the data with the first MAC address and the second MAC address in a first packet to transmit to the second IP-based device, the second IP-based device encloses the first packet with the first IP address and the second IP address in a second packet to transmit to the first IP-based device, the first IP-based device removes the first IP address and the second IP address from the second packet to form a third packet and transmits the third packet to the first network device, and the first network device extracts the data from the third packet.

8. The connecting method of claim 6 further comprising utilizing the host for allocating the first and the second IP addresses.

9. The connecting method of claim 6 further comprising utilizing the first IP-based device for recording the first MAC address, and utilizing the second IP-based device for recording the second MAC address.
